(19) United States
(12) Patent Application Publication
(10) Pub. No.: US 2001/0053988 A1
(43) Pub. Date: Dec. 20, 2001

(54) Method for providing assets fluctuation stock insurance services

(76) Inventor: Kyung M. Park, Seoul (KR)

Correspondence Address: HARNESS, DICKEY & PIERCE, PLC, P.O. BOX 828, BLOOMFIELD HILLS, MI, 48303, US

(21) Appl. No.: 09/851,308

(22) Filed: May 8, 2001

(30) Foreign Application Priority Data
May 15, 2000 (KR) 2000-25855

(51) Int. Cl. G06F 17/60

(52) U.S. Cl. 705/4; 705/37

(57) ABSTRACT

1. Field of the invention described in the claim

The present invention relates to a method for providing assets fluctuation stock insurance services and a computer-readable record medium for storing a program of realizing the method.

2. Technical subject to be solved by the invention

The object of the present invention is to provide a method for providing assets fluctuation stock insurance services in order for all the investors and companies to operate stable funds through stocks trading and self-keeping under controls of a computing system and a computer-readable record medium for storing a program to realize the method.

3. Gist of the solution by the invention

The present invention comprises the steps of (1) accepting an initial entry of a holding financial company for assets fluctuation stock insurance services by an assets fluctuation management server; (2) determining shares of participant companies based on assets ratios and carrying out share swaps among the participant companies and the holding financial company by the assets fluctuation management server; (3) determining and carrying out allocations of a predetermined share of the shares the holding financial company have swapped based on evaluations of the participant companies by the assets fluctuation management server; (4) verifying market value fluctuations of the holding financial company and determining swap ratios of additional participant companies by the assets fluctuation management server; and (5) storing in a data storage unit and managing items on operations and fluctuations of the holding financial company by the assets fluctuation management server.

4. Important use of the invention

The present invention is used for financial services and the like.

### BACKGROUND OF THE INVENTION

1. Field of the Invention

The present invention relates to a method for providing assets fluctuation stock insurance services and a computer-readable record medium for storing a program of realizing the method, and more particularly to a method for providing assets fluctuation stock insurance services to trade shares and to secure stable funds through a computing system and a computer-readable record medium for storing a program of realizing the method.

2. Reference to Related Patents Applications

U.S. Pat. No. 5,193,056 Data processing system for hub and spoke financial services configuration

U.S. Pat. No. 5,819,230 System and method for tracking and funding asset purchase and insurance policy

U.S. Pat. No. 5,832,461 System and method of investment management including means to adjust deposit and loan accounts for inflation

U.S. Pat. No. 6,035,286 Computerized system and method for creating a buyback stock investment report

U.S. Pat. No. 6,070,153 System and method for automatically investing a portion of a credit card interest charged amount in an investment account

U.S. Pat. No. 6,173,270 Stock option control and exercise system

3. Description of Related Art

Up to now, angel investors have individually or jointly by forming funds invested to venture or newly founded companies. However, a problem occurs in recovering the invested funds in case that companies invested go bankrupt

Further, if situations a venture or a newly founded company invested goes bankrupt occur even in case that major stockholders of the company have lots of stocks of the corresponding company, a problem occurs that the stockholders can not sell the stocks even though they tend to recover the company through the disposal of the stocks they have.

Furthermore, venture or newly founded companies need increasing capital, but compensations such as share allocations should be required for the increased capital, so a problem exists since it is difficult to solve two matters of stable company operations and capital increases at the same time.

### SUMMARY OF THE INVENTION

The present invention has been devised to solve the above problems, so it is an object of the present invention to provide a method for providing assets fluctuation stock insurance services in order for all the investors and companies to operate stable funds through stocks trading and self-keeping under controls of a computing system and a computer-readable record medium for storing a program to realize the method.

In order to achieve the above object, the present invention, in a method for providing assets fluctuation stock insurance services, which is applied to a computing system, comprises steps of: (1) accepting an initial entry of a holding financial company for assets fluctuation stock insurance services by an assets fluctuation management server; (2) determining shares of participant companies based on assets ratios and carrying out share swaps among the participant companies and the holding financial company by the assets fluctuation management server; (3) determining and carrying out allocations of a predetermined share of the shares the holding financial company have swapped based on evaluations of the participant companies by the assets fluctuation management server; (4) verifying market value fluctuations of the holding financial company and determining swap ratios of additional participant companies by the assets fluctuation management server; and (5) storing in a data storage unit and managing items on operations and fluctuations of the holding financial company by the assets fluctuation management server.

Further, the present invention provides a computer-readable record medium, in a computing system having a mass capacity processor, for storing a program of realizing functions of: (1) accepting an initial entry of a holding financial company for assets fluctuation stock insurance services; (2) determining shares of participant companies based on assets ratios and carrying out share swaps among the participant companies and the holding financial company; (3) determining and carrying out allocations of a predetermined share of the shares the holding financial company have swapped based on evaluations of the participant companies; (4) verifying market value fluctuations of the holding financial company and determining swap ratios of additional participant companies; and (5) storing in a data storage unit and managing items on operations and fluctuations of the holding financial company.

### BRIEF DESCRIPTION OF THE DRAWINGS

The above object and other advantages of the present invention will become more apparent by describing in detail a preferred embodiment thereof with reference to the attached drawings, in which:

FIG. 1 is a view for showing a structure of a computing system according to an embodiment of the present invention;

FIG. 2 is a view for showing a structure of a network system according to an embodiment of the present invention; and

FIG. 3 is a flow chart for a method for providing assets fluctuation stock insurance services according to an embodiment of the present invention.

### DETAILED DESCRIPTION OF THE PREFERRED EMBODIMENT

Hereinafter, a preferred embodiment of the present invention will be described in detail with reference to the accompanying drawings.

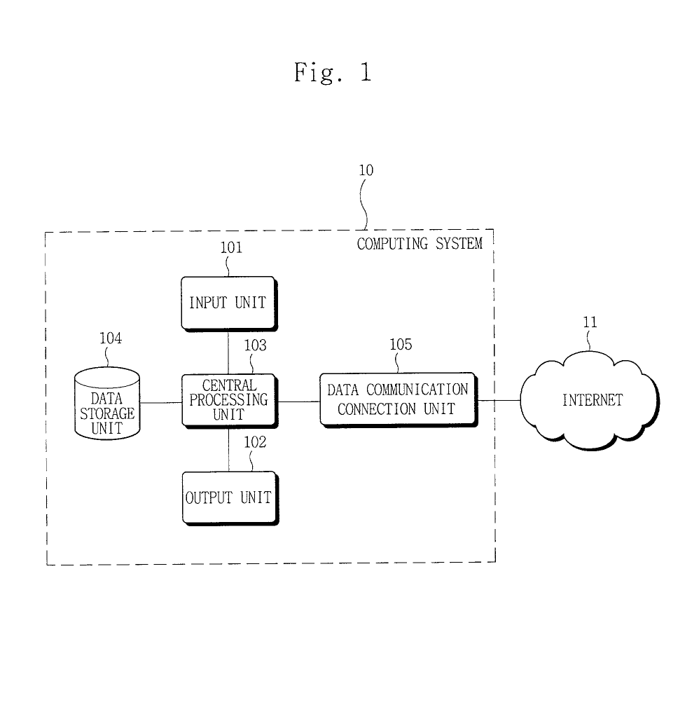

FIG. 1 is a view for showing a structure of a computing system according to an embodiment of the present invention.

A computing system 10 applied to the present invention connects to a data communication network such as the internet 11 in order for data communications to be enabled through the network.

The computing system 10 includes an input unit 101 for receiving inputs from users, an output unit 102 for presenting outcomes and progress situations to the users, a central processing unit 103 for controlling the system for administration and carrying out algorithm for processes according to processing requests, a data storage unit 104 for storing data in accordance with requests of the central processing unit 103, and a data communication connection unit 105 in charge of connections to the data communication network of the computing system 10.

In the present invention, assets managements are carried out according to the control and administration of the central processing unit 103 in the computing system 10.

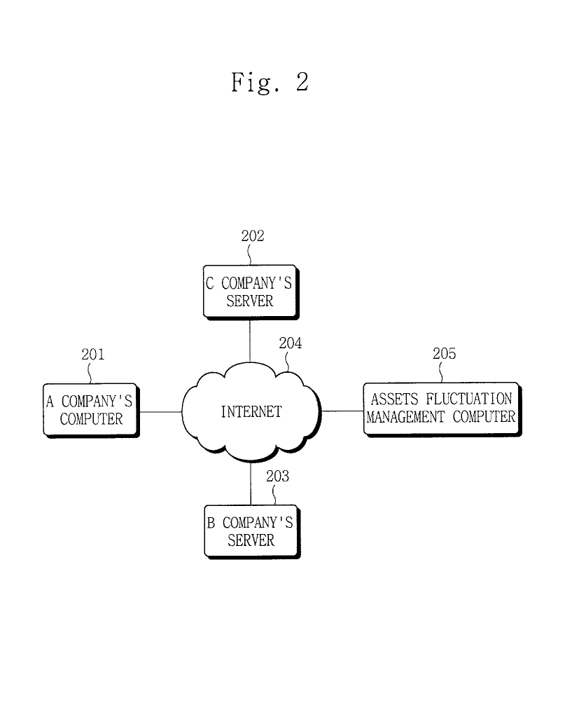

FIG. 2 is a view for showing a structure of a network system applied to an embodiment of the present invention

The network system applied to the present invention is accomplished through a network connection of the computing system 10 shown in FIG. 1.

The network system, as shown in FIG. 2, includes an A company's computer 201, a B company's server 202, a C company's server 203, the internet 204, and an assets fluctuation managements computer 205.

The A company's computer 201, B company's computer 202, and C computer's computer 203 are entered into the assets fluctuation stock insurance services to correspond to the computing system for managing assets of their own.

The assets fluctuation management computer 205 is a computing system for providing an assets fluctuation stock insurance service according to the present invention.

The internet 204 connects the computing system as stated above to a network.

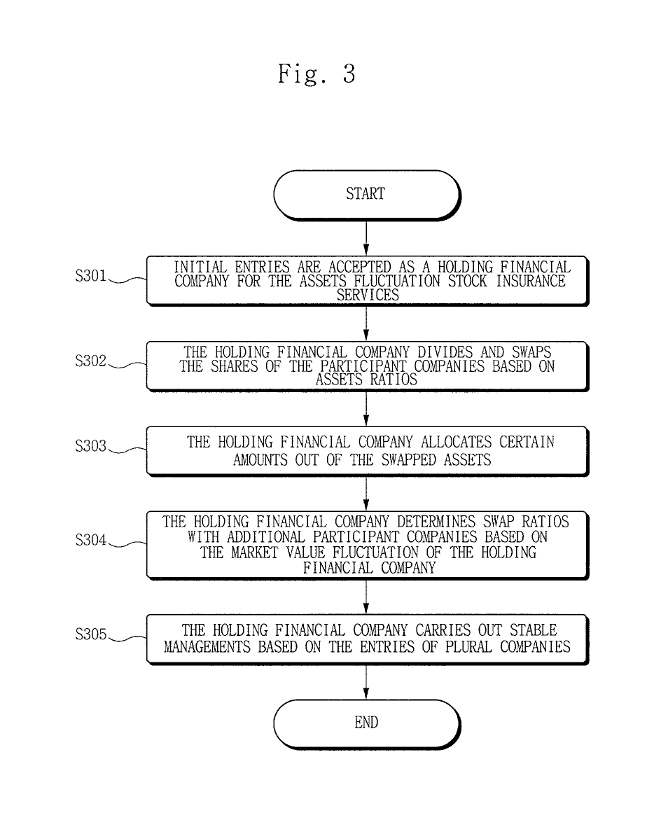

FIG. 3 is a flow chart for a method for providing assets fluctuation stock insurance services according to an embodiment of the present invention.

Concepts on the assets fluctuation stock insurance services start with the follows:

providing a system for protecting angel members

continuous increases and efficient managements of angel members

creating an effective group value for an excellent venture company group

early implementing values and continuously creating values

preparing a structural system for early advent of next markets.

In order to achieve the above objects, the assets fluctuation stock insurance services have been proposed. The environments are as follows.

timing for venture companies to be recognized to be settled in the market

timing for angel members to realize profits

timing for markets to need the value of the A company

timing objectively recognized over investments (That is, timing anticipated over the tie-up of an investment profit rate)

The assets fluctuation stock insurance services can be accomplished at the time stated above.

The principle is as follows:

Insurance: insurance (deduction) functions to angle group members/representative directors/companies

stock swap: investment methods not accompanying cash at first hand, and early realization of holding assets

leverage effect: early recoveries of invested principal and interest amounts and multiplied effects for investment opportunities

Holding financial company investment: direct investment functions

others: participating in capital increases of each company and participating in a pool (joint investment) method in necessity of liquidity.

Considerations in view of business fields for the above is as follows:

first stage

insurance (deduction) function: angel group members, venture companies, representative directors (major stockholders)

functions of holding financial companies

direct investment function

second stage

index function

funds function as indirect investment goods

The concepts as described above are defined in detail as below through an embodiment of the present invention.

First, first 10 or more companies are consisted of and classified into fixed, ongoing, and participating major companies

The A company swaps by assets ratio of the first 10 companies with a share 5% of each company set in a face value(2% in case that shares of the major companies are low) (For an instance, in case that the assets value of the 10 companies amounts to 11 billion won, since 25% of the assets value out of a swap room is swapped, a present value of an estimated market becomes 44 billion won. By reference to this, the respective 10 companies swaps by ratio) . At this time, examination members evaluate items such as an offering price (estimated offering price), a market price, potential markets, potential market capacities, and so on, and calculate an estimated price.

Next, an additional swap is carried out.

Since the time when the value of the A company becomes “0” is the time when all of the first 10 companies and other companies joined later are dishonored at the same date and time, the risk converges into zero as the number of member companies (that is, assets companies) for the A company increases.

A 10% out of a first 40% swap room is distributed according to an estimated amount and, in case of additional companies, a swap is carried out by ratio considering the market value of the A company. Accordingly, as the assets value and market value of the A company increase, a sell swap ratio of the A company based on the swap with the respective companies decreases. For example, if a swap ratio is 4:1 in case of first 10 companies, a swap ratio will be over at least 16:1 based on an assets value ratio of the A company in case of secondary participation companies (upon assumption of a four times increase). The above is a theoretical ratio, and the leverage effect will be much more multiplied from the time when a stock price reflecting the future value of the A company is formed in the over-the-court market.

Accordingly, companies participating in angel markets hope to swap with the A company, and angel group members focus on whether the A company swaps or makes direct investments, and, since general individual investors desire to join the angel group for minimum security, the number of angel group members increases, so that the companies swapped with the A company can surely fix the lead of the industries. Therefore, the companies swapped with the A company are to be verified as a royal venture group in fact, and the brand value of the A company increases much more with the substantial completion of funding.

The principal contents of contracts for the above are as follows.

First, the A company holds a 50% of the share of the A company which is possessed by the companies to be swapped with the A company following the first 10 companies in order to protect individual investors of the angel group until the A company is listed to Kosdaq, a third market, a trading market having an equivalent function of the third market, or stock exchange. When each company goes dishonored, the principal of the angel group members invested to the same company is preferentially allocated based on a principle considering investment amount ratios of the members.

Second, even though each company goes dishonored, it is possible that a share of the A company each company (or major stockholders) holds is sold to be used as recovery funds. Since the share of the A company held based on the investments of major stockholders can be freely sold in the market, the share has an insurance function to the major stockholders themselves.

Third, the representative directors of companies joining in the future are granted priorities by which they purchase shares of the A company preferentially as the A company increases its capital.

Based on the above description, a method for providing assets fluctuation stock insurance services according to the present invention will be described in detail through a flow shown in the drawings.

First, as stated above, initial entries are accepted as a holding financial company for the assets fluctuation stock insurance services(301). And then, information of the entered companies is stored in a database by the assets fluctuation management computer.

The assets fluctuation management computer of the holding financial company divides and swaps the shares of the participant companies based on assets ratios(302).

The assets fluctuation management computer of the holding financial company determines amounts to be assigned based on evaluated amounts out of the swapped assets and then allocates certain amounts out of the swapped assets (303). The information on allocations is stored in the database by the assets fluctuation management computer.

The assets fluctuation management computer of the holding financial company determines swap ratios with additional participant companies based on the market value fluctuation of the holding financial company (304).

The assets fluctuation management computer of the holding financial company carries out stable managements based on the entries of plural companies(305). Accordingly, the assets fluctuation stock insurance services is operated and maintained based on the managements of the assets fluctuation management computer and the stability of the assets fluctuation stock insurance services themselves.

The present invention as stated above has an effect in that the A company holds a proper share of the A company which is possessed by the companies to be swapped with the A company following the first participant companies in order to protect investors through the assets fluctuation stock insurance services, and, when each company goes dishonored, the principal of the angel group members invested to the same company is preferentially allocated based on a principle considering investment amount ratios of the members.

Further, the present invention has an effect in that, even though each company goes dishonored, it is possible that a share of the A company each company holds is sold to be used as recovery funds.

Furthermore, the present invention has an effect in that, since the share of the A company held based on the investments of major stockholders can be freely sold in the market, the share has an insurance function to the major stockholders themselves.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A method for providing assets fluctuation stock insurance services, which is applied to a computing system, comprising steps of:
(1) accepting an initial entry of a holding financial company for assets fluctuation stock insurance services by an assets fluctuation management server;
(2) determining shares of participant companies based on assets ratios and carrying out share swaps among the participant companies and the holding financial company by the assets fluctuation management server;
(3) determining and carrying out allocations of a predetermined share of the shares the holding financial company have swapped based on evaluations of the participant companies by the assets fluctuation management server;
(4) verifying market value fluctuations of the holding financial company and determining swap ratios of additional participant companies by the assets fluctuation management server; and
(5) storing in a data storage unit and managing items on operations and fluctuations of the holding financial company by the assets fluctuation management server.

2. The method as claimed in claim 1, further comprising steps of:
(6) keeping a certain part of the shares swapped under the administration of the assets fluctuation management server and preparing for fluctuations of the participant companies by the holding financial company; and
(7) allocating to investors the holding financial company share of the participant companies under the administration of the assets fluctuation management server and carrying out protection of the investments when problems occur to the participant companies.

3. The method as claimed in claim 2, further comprising a step of (8) enabling the problems to be solved through movements of the share of the holding financial company when the problem occurs to the companies that have swapped shares with the holding financial company, and storing the movements into a database of the assets fluctuation management server.

4. The method as claimed in claim 1, further comprising a step of (6) enabling the problems to be solved through movements of the share of the holding financial company when the problem occurs to the companies that have swapped shares with the holding financial company, and storing the solved problems into a database of the assets fluctuation management server.

5. A computer-readable record medium, in a computing system having a mass capacity processor, for storing a program of realizing functions of:
(1) accepting an initial entry of a holding financial company for assets fluctuation stock insurance services;
(2) determining shares of participant companies based on assets ratios and carrying out share swaps among the participant companies and the holding financial company;
(3) determining and carrying out allocations of a predetermined share of the shares the holding financial company have swapped based on evaluations of the participant companies;
(4) verifying market value fluctuations of the holding financial company and determining swap ratios of additional participant companies; and
(5) storing in a data storage unit and managing items on operations and fluctuations of the holding financial company.

6. The computer-readable record medium as claimed in claim 5, further comprising functions of:
(6) processing the keeping and managing of a certain part of the swapped shares based on a request from the holding financial company and preparing for fluctuation of the participant companies; and
(7) allocating to investors the holding financial company share of the participant companies under administration and carrying out protection of the investments when problems occur to the participant companies.

7. The computer-readable record medium as claimed in claim 6, further comprising functions of (8) enabling the problems to be solved through movements of the share of the holding financial company when the problem occurs to the companies that have swapped shares with the holding financial company, and storing the movements into a database of the assets fluctuation management server; and
(9) storing in a database and managing the movements of the share of the holding financial company.

8. The computer-readable record medium as claimed in claim 5, further comprising functions of (6) enabling the problems to be solved through movements of the share of the holding financial company when the problem occurs to the companies that have swapped shares with the holding financial company, and storing the movements into a database of the assets fluctuation management server; and
(7) storing in a database and managing the movements of the share of the holding financial company.
